(19) United States
(12) Patent Application Publication
(10) Pub. No.: US 2026/0089515 A1
(43) Pub. Date: Mar. 26, 2026

(54) END-TO-END LEARNING OF CSI FEEDBACK FUNCTIONS

(71) Applicant: InterDigital Patent Holdings, Inc., Wilmington, DE (US)

(72) Inventors: Mohamed Amine Arfaoui, Montreal (CA); Philip Pietraski, Jericho, NY (US); Asil Koc, Verdun (CA); Guodong Zhang, Woodbury, NY (US); John Kaewell, Jamison, PA (US)

(73) Assignee: InterDigital Patent Holdings, Inc., Wilmington, DE (US)

(21) Appl. No.: 18/897,741

(22) Filed: Sep. 26, 2024

(51) Int. Cl. H04W 24/02; H04B 7/06; H04W 72/21; H04W 72/51

(52) U.S. Cl. CPC H04W 24/02; H04B 7/0626; H04W 72/21; H04W 72/51

(57) ABSTRACT

A wireless transmit/receive unit (WTRU) and a network (NW) may perform end-to-end training of an artificial intelligence (AI) or machine learning (ML) model for channel state information (CSI) feedback. The NW may generate training data for the training using a set of one or more seed values. The WTRU may be aware of the seed values and may use them to generate ground truth data, which can be used to determine the value of an end-to-end error and/or loss function. The WTRU and the NW may compute or approximate derivatives of the loss function and may send one another the derivatives. The WTRU and the NW may utilize the derivatives to update one or more AI or ML models.

### BACKGROUND

Artificial intelligence (AI) may be broadly defined as behavior exhibited by machines that mimic cognitive functions to sense, reason, adapt and act. An AI component may refer to the realization of behaviors and/or conformance to requirements by learning based on data, without explicit configuration of sequence of steps of actions. AI components may enable learning complex behaviors which might be difficult to specify and/or implement using legacy methods.

Machine learning (ML) may refer to a type of algorithms that solve a problem based on learning through experience (e.g., data), without being explicitly programmed (e.g., without configuring a set of rules). ML can be considered as a subset of AI. Different ML paradigms may be envisioned based on the nature of data or feedback available to the learning algorithm. In examples, a supervised learning approach may involve learning a function that maps input to an output based on labeled training examples, wherein each training example may be a pair consisting of an input and its corresponding output. In examples, an unsupervised learning approach may involve detecting patterns in the data with no pre-existing labels. In examples, a reinforcement learning approach may involve performing sequence of actions in an environment to maximize the cumulative reward. In some solutions, it is possible to apply ML algorithms using a combination or interpolation of the above-mentioned approaches. For example, a semi-supervised learning approach may use a combination of a small amount of labeled data with a large amount of unlabeled data during training. In this regard semi-supervised learning falls between unsupervised learning with no labeled training data and supervised learning with labeled training data.

### SUMMARY

A wireless transmit/receive unit (WTRU) may perform end-to-end learning of channel state information (CSI) feedback functions. Systems may use artificial intelligence (AI) and/or machine learning (ML) models for CSI feedback functions. A WTRU may enable end-to-end learning of CSI feedback functions.

The WTRU may determine to perform training of an AI or ML model with a network (NW). In examples, the WTRU may receive a request from the NW for information related to the WTRU's CSI feedback capabilities. The WTRU may (e.g., responsive to the request) transmit an indication that the WTRU supports end-to-end learning of AI or ML CSI feedback functions. The WTRU may determine to perform training of an AI or ML CSI feedback function (e.g., upon receiving an indication from the NW that a CSI feedback function training session is starting). The NW may send the WTRU configuration information for end-to-end learning for an AI/ML CSI feedback function.

The WTRU may receive a CSI reference signal (RS) (e.g., from the NW). The WTRU may generate (e.g., using an AI or ML encoder) and send a CSI feedback report to the network entity based on the CSI RS. The NW may construct a downlink CSI estimate based on the CSI feedback report (e.g., using an AI or ML decoder).

The NW may generate training data based on a set of one or more seeds. In examples, training data can be binary bits or symbols. For cases where the training data are binary bits, the NW may generate the binary bits based on a set of one or more seeds. The NW may apply channel encoding (e.g., with a configured coding scheme) to generate the associated coded binary bits or may generate binary bits as a surrogate to the coded binary bits without channel encoding. Then, the NW may apply modulation to the binary bits to generate symbols. For the case where the training data are symbols, the NW may generate symbols based on a set of one or more seeds and a configured modulation. For one or more (e.g., all) cases, the NW may apply the training data to the downlink transmission blocks to generate downlink data and send the downlink data to the WTRU.

The WTRU may determine a set of training data (e.g., uncoded bits, coded/soft bits, symbols, etc.) based on the received downlink data. The WTRU may determine the set of received training data based on the received downlink data.

The WTRU may determine a set of seed values. In examples, the WTRU may be preconfigured with the seed values. In examples, the WTRU may receive an indication of the seed values from the network entity. The WTRU may generate the set of ground truth training data (e.g., uncoded bits, coded bits, symbols, etc.) generated by the NW based on the seed values. The WTRU may compute an error metric or statistic based on comparing the ground truth training data with the received training data. The WTRU may determine an end-to-end loss function based on the set of received training data and the set of ground truth training data.

The WTRU may compute a set of one or more derivatives or gradients based on the loss function (e.g., with respect to a set of one or more AI/ML model parameters). The WTRU may send an indication of the derivatives to the network entity. The NW may compute a second set of one or more derivatives (e.g., based on the received indication of the derivatives from the WTRU). The NW may send an indication of the second set of derivatives to the WTRU. The WTRU and/or the NW may update one or more AI or ML models for CSI feedback functions (e.g., an encoder and/or a decoder) based on the computed/received error metric or statistic determined by the WTRU. In examples, the WTRU and/or NW may perform backpropagation and/or a learning algorithm, such as a gradient descent algorithm, when updating the AI or ML models.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is a system diagram illustrating an example of CSI feedback reporting and downlink data transmission.

FIG. 3A and FIG. 3B are diagrams illustrating an example of a process for end-to-end learning for CSI feedback functions.

FIG. 4 is a diagram illustrating an example of CsiNet model architecture.

FIG. 5 is a line chart showing throughput versus signal-to-noise ratio (SNR) of the proposed solution and the baselines for the CSI Compression use case.

FIG. 6 is a line chart showing throughput versus SNR of the proposed solution and the baselines for the CSI Joint CSI Estimation, Prediction, and Compression use case.

### DETAILED DESCRIPTION

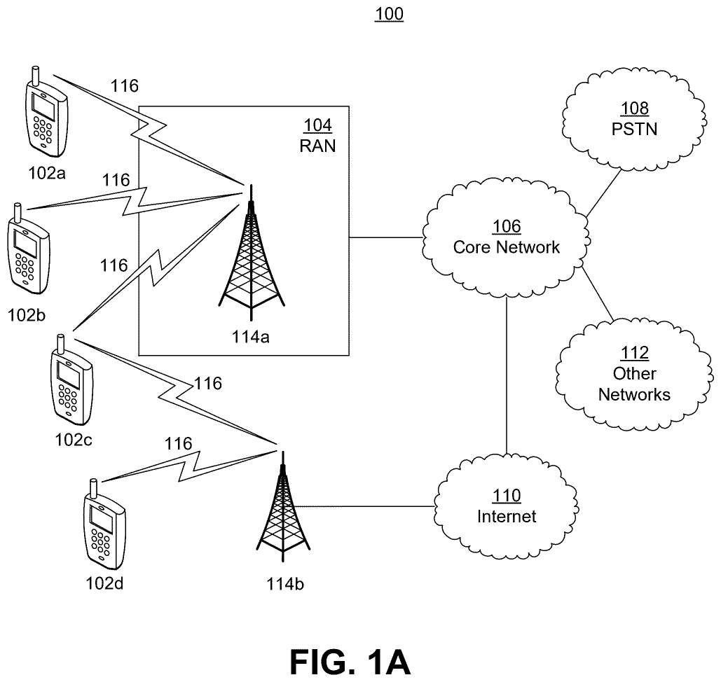

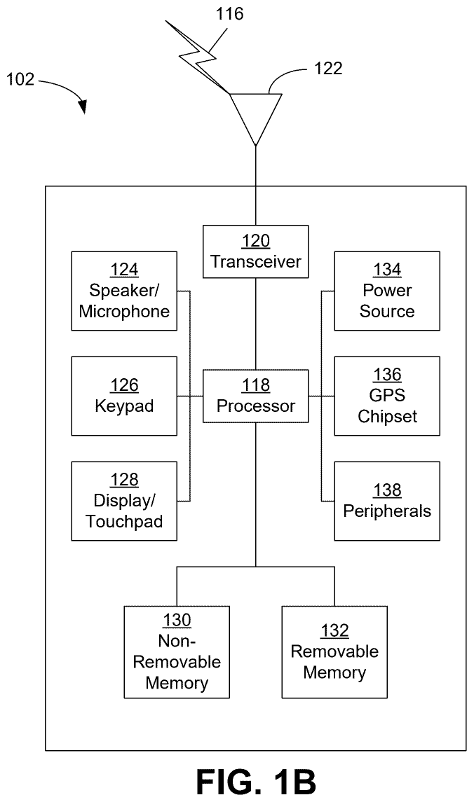

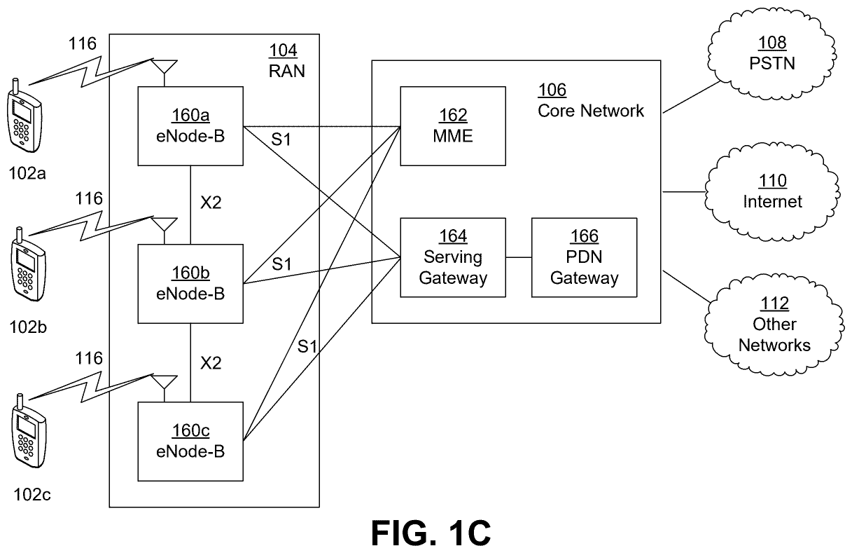

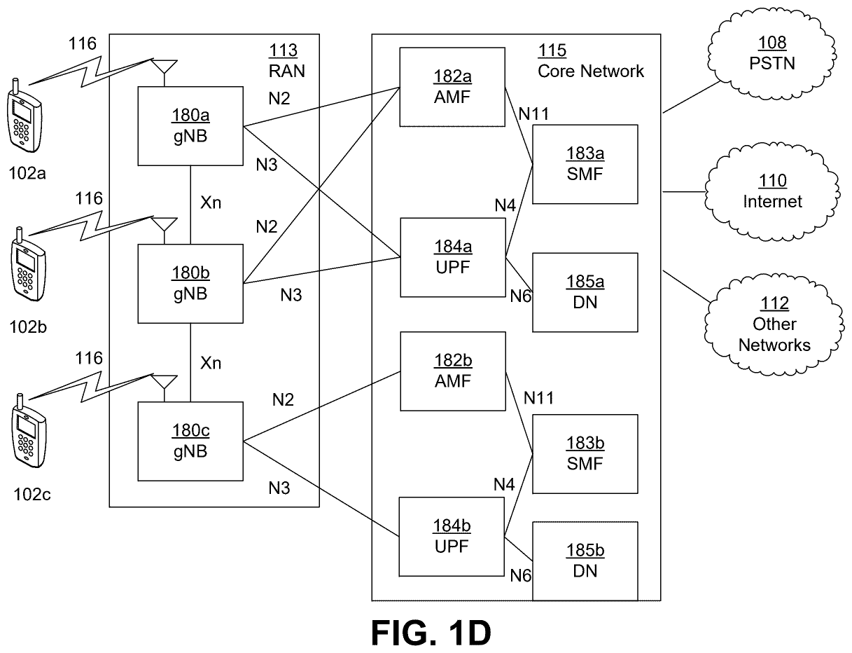

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU. Further, any description herein that is described with reference to a UE may be equally applicable to a WTRU (or vice versa). For example, a WTRU may be configured to perform any of the processes or procedures described herein as being performed by a UE (or vice versa).

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general-purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134 and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily, or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a,184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Deep learning refers to a class of machine learning (ML) algorithms that employ artificial neural networks, specifically, Deep Neural Networks (DNNs), which were loosely inspired from biological systems. The DNNs are a special class of ML models that are inspired by the human brain wherein the input is linearly transformed and passes through a non-linear activation function one or more times. DNNs typically comprise multiple layers. Each layer may comprise a linear transformation and/or non-linear activation functions. DNNs can be trained using the training data via a back-propagation algorithm. Recently, DNNs have shown state-of-the-art performance in a variety of domains (e.g., speech, vision, natural language, wireless communication, etc.), and for various ML settings (e.g., supervised, un-supervised, semi-supervised, etc.).

Auto-encoders (AEs) are specific class of deep neural networks (DNNs) that can be used in the context of un-supervised machine learning. In such settings, high-dimensional data may be non-linearly transformed to a lower dimensional latent vector using a DNN based encoder. The lower dimensional latent vector may then be used to reconstruct the high-dimensional data using a non-linear decoder. The terms “encoder” and “decoder” are sometimes, but not always, meant to be parts of an autoencoder. The encoder may be represented as E(x; Wₑ) where x is the high-dimensional data and Wₑ represents the parameters of the encoder. The decoder may be represented as D(z; W_{d}) where z is the low-dimensional latent representation and W_{d} represents the parameters of the decoder. Using training data {x₁, . . . , x_{N}} the auto-encoder can be trained by solving the following optimization problem.

$$\{ {W}_{e}^{tr} , {W}_{d}^{tr} \} = arg {min}_{{W}_{e} , {W}_{d}} {\sum }_{i = 1}^{N} {‖ {x}_{i} - D ( E ( {x}_{i} ; {W}_{e} ) ; {W}_{d} ) ‖}_{2}^{2} . \qquad Equation 1$$

The above problem can be approximately solved using a backpropagation algorithm. The trained encoder

$$E ( x ; {W}_{e}^{tr} )$$

can be used to compress the high-dimensional data and the trained decoder

$$D ( z ; {W}_{d}^{tr} )$$

can be used to reconstruct the high-dimensional data from the latent representation.

CSI feedback functions include a series of functions implemented at the WTRU side to enable the estimation of the channel state information (CSI) and its transmission to the network (NW). The NW can exploit the received CSI feedback to apply link adaptation functions to the WTRU (e.g., appropriate MCS and precoding, beam management, power allocation, RB allocation, etc.). The CSI feedback functions include the CSI estimation, from which the UE can generate a CSI report containing CSI feedback information (e.g., measurements, indicators of the channel quality, such as CQI, PMI, RI, and LI, etc.). CSI feedback functions also include CSI prediction, CSI compression, as well as combinations between these two functions. These CSI feedback functions are discussed below.

Recent advances have been made, relating to AI/ML for CSI Feedback Enhancement.

Mechanisms and frameworks exist for using AI/ML based approaches at the air interface level. For example, the study item “Study on Artificial Intelligence (AI)/Machine Learning (ML) for NR air interface” in 3GPP Release 18 includes a use case on “Evaluation on AI/ML for CSI feedback enhancement”. Within this use case, two sub-use cases were introduced and agreed, which are, namely, spatial/frequency (SF) CSI compression and temporal CSI prediction.

SF CSI compression includes the operation of compressing the CSI estimates in the spatial/frequency (SF) domain by the WTRU (e.g., using AEs) to a quantized-binary representation with a predefined feedback size (e.g., in bits) and transmitting it to the NW. The NW, in turn, may reconstruct the SF CSI estimates by decompressing the received CSI feedback from the WTRU.

Temporal CSI prediction refers to predicting posterior SF CSI, either by the WTRU or by the NW (e.g., from historical SF CSI estimates).

The two sub-use cases discussed herein are within the CSF functions and are implemented after the CSI estimation function.

3GPP has continued specifying mechanisms and frameworks for using AI/ML based approaches at the air interface level. Specifically, the study item “9.1.3 Additional study on AI/ML for NR air interface” continues the feasibility study of temporal CSI prediction and extends the feasibility study of SF CSI compression to temporal/spatial/frequency (TSF) CSI compression, to CSI compression plus prediction, and to joint CSI compression and prediction.

TSF CSI compression refers to generating a quantized-binary representation of the CSI with a predefined feedback size (e.g., in bits) based on the current and the prior SF CSI estimates, and then transmitting it to the NW. The NW, in turn, can reconstruct the current SF CSI estimate by jointly incorporating the reconstructed prior SF CSI estimates and the received CSI feedback from the WTRU.

CSI compression plus prediction refers to concatenating the SF/TSF CSI compression and the temporal CSI prediction operation in a cascaded manner. The order of concatenation (e.g., compression first or prediction first) are Interchangeable.

Joint CSI compression and prediction refers to jointly performing CSI compression and prediction within a single function block. For example, joint CSI compression and prediction may comprise generating a quantized-binary representation with a predefined feedback size (e.g., in bits) based on the current and the prior SF CSI estimates, and then transmitting it to the NW. The NW, in turn, can reconstruct the posterior SF CSI estimates by jointly incorporating the reconstructed prior SF CSI estimates and the received CSI feedback from the WTRU.

Existing and proposed AI/ML solutions for CSI feedback functions rely on training the AI/ML models offline, based on loss functions that are mapped to intermediate key performance indicators (KPIs), such as mean square error (MSE), cosine similarity (CS), etc. 3GPP did not consider CSI estimation for channel sounding as an AI/ML use case for NR air interface. Furthermore, it is not guaranteed that training AI/ML models using intermediate KPIs can achieve the best possible end-to-end performance (e.g., bit error rate (BER), block error rate (BLER), Throughput), since there is no direct mapping between the intermediate KPIs (e.g., MSE, CS) and the end-to-end KPIs (e.g., BER, BLER, Throughput). Furthermore, such an approach cannot adapt to practical limitations of the radio channel (e.g., very short channel coherence time and bandwidth, phase and impulsive noise, etc.) and transceiver hardware (e.g., non-linear power amplifier, phase-noise, hybrid analog-digital processing, low quantization resolution, etc.) in deployment. Therefore, to resolve the aforementioned limitations, a solution that can enable the end-to-end learning of CSI feedback functions (e.g., learning with respect to end-to-end KPIs) is highly desired.

Solutions involving end-to-end learning of CSI feedback functions with over-the-air gradient transmission are discussed herein. To ensure AI/ML models for CSI feedback functions can achieve the best possible end-to-end performance and can efficiently adapt to practical limitations of the radio channel and transceiver hardware, these solutions develop an end-to-end learning mechanism for CSI feedback functions, for example, with respect to end-to-end KPIs. These solutions enable learning DL precoders that improve end-to-end KPIs (e.g., BER, BLER, Throughput) that account for the constraints of the available hardware and the radio environment. In summary, these solutions provide the WTRU steps, structure, and procedures to perform end-to-end learning of CSI feedback functions.

CSI feedback functions may be based on one-sided AI/ML models, such as CSI estimation, CSI prediction, joint CSI estimation and prediction, etc. Additionally, or alternatively, CSI feedback functions may be based on two-sided AI/ML models, wherein one side resides at the WTRU, and one side resides at the NW, such as CSI compression, joint CSI estimation and compression, joint CSI prediction and compression, joint CSI estimation, prediction, and compression, etc. For the purpose of illustration, CSI compression is discussed herein as an example.

Training of AI/ML models may involve forward pass operation and/or updating model parameters (e.g., via backpropagation). The Forward Pass is discussed below.

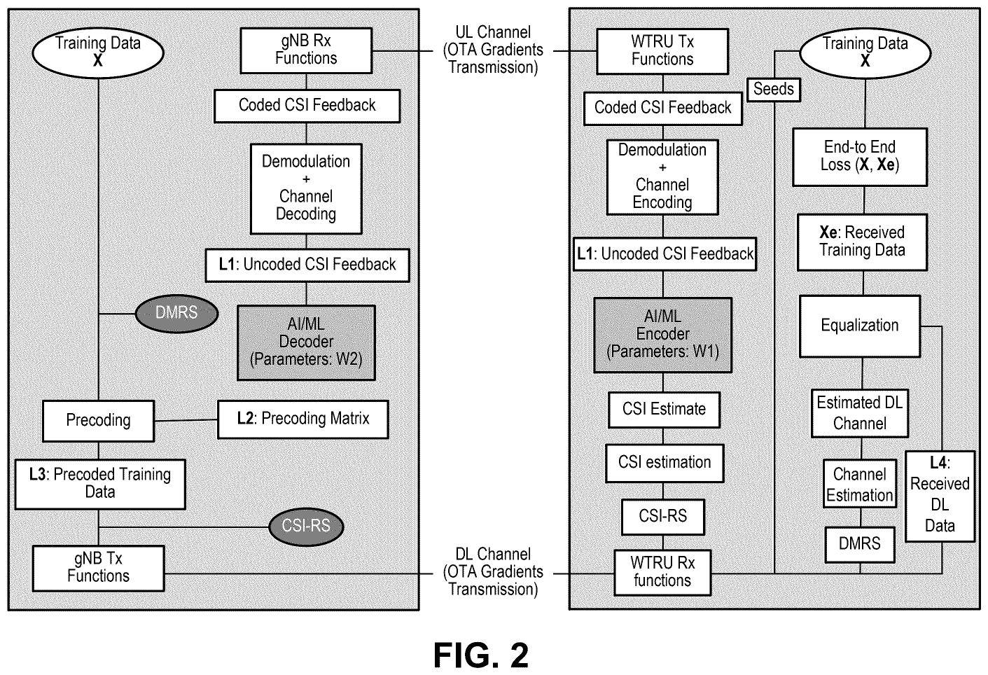

For the case of CSI compression, which is an example of on two-sided AI/ML-based CSI feedback function, and as depicted in FIG. 2, the NW may transmit pilot signals (e.g., a CSI-RS) to the WTRU for the purpose of channel sounding. The WTRU may receive the CSI-RS and performs CSI estimation. Then, the WTRU may compress the CSI estimate, using its AI/ML model (e.g., encoder), into a CSI feedback message, denoted by L₁. The WTRU may apply quantization, channel encoding and modulation to the CSI feedback message. Afterwards, the WTRU may transmit the CSI feedback message to the NW in the uplink in UCI, either in PUCCH or PUSCH. At the NW side, the NW may receive the CSI feedback message and applies demodulation and channel decoding. Then, the NW may generate the DL precoder, denoted by L₂, associated with the CSI feedback message, using its AI/ML model (e.g., decoder).

To enable end-to-end learning of CSI feedback functions, the WTRU may have the capability to regenerate the information (e.g., training data) that was transmitted by the NW to be able to compute the end-to-end loss function (e.g., binary cross-entropy (BCE), approximate bit-error-rate (BER), approximate symbol-error-rate, etc.). This can be realized using pseudo-random data specific for jointly training the AI/ML models at the WTRU and the NW. For example, the NW may generate pseudo-random training data with a set of one or more seeds. The set of seeds can be either preconfigured and/or dynamically configured by the NW and then signaled to the WTRU. As such, the WTRU can regenerate the ground-truth training data that were transmitted by the NW. Based on this, the NW may generate the training data, which are denoted by X.

In examples, training data can be binary bits or symbols. For cases where the training data are binary bits, the NW may generate the binary bits based on a set of one or more seeds. The NW may apply channel encoding (e.g., with a configured coding scheme) to generate the associated coded binary bits or may generate binary bits as a surrogate to the coded binary bits without channel encoding. Then, the NW may apply modulation to the binary bits to generate symbols. For the case where the training data are symbols, the NW may generate symbols based on a set of one or more seeds and a configured modulation. Afterwards, for one or more (e.g., all) cases, the NW may map the generated symbols to DL resource elements (REs) and insert DMRS. After this, the NW may apply precoding using the generated DL precoder from its AI/ML model (e.g., decoder), and then transmit the precoded training data, denoted by L₃, to the WTRU.

At the WTRU side, the WTRU may extract the DMRS from the received signal and apply preprocessing. Then, the WTRU may estimate the effective DL channel (e.g., precoded channel) using the extracted DMRS. Then, the WTRU may extract the DL data, denoted by L₄, from the received signal and may apply preprocessing. Afterwards, the WTRU may employ the estimated DL effective channel to equalize the received DL data using a certain equalizer (e.g., zero-forcing (ZF), minimum mean square error (MMSE), etc.) to estimate the received training data, which are denoted by Xₑ. For cases where the training data are uncoded binary bits, the WTRU may apply soft-symbol-demapper (SSD) and/or soft-output channel decoder to estimate the uncoded binary bits generated by the NW. For cases where the training data are coded binary bits, the WTRU may apply soft-symbol-demapper (SSD) to estimate the soft bits relative to the coded binary bits generated by the NW. In parallel, the WTRU may employ the same seeds (e.g., preconfigured or received dynamically from the NW) that the NW used to generate the pseudo-random training data, to regenerate the same ground truth training data X. At this stage, the WTRU may compute a loss as a measured difference (e.g., or a distance or a similar statistic) between the generated training data X and the estimated training data Xₑ. The measured difference may be a statistic that may be mapped to an end-to-end KPI, and it can be either preconfigured or configured dynamically by the NW. For cases where the training data are uncoded or coded binary bits, examples of the measured difference can be the binary-cross-entropy (BCE) or approximate bit-error-rate (BER). For cases where the training data are symbols, an example of the measured difference can be the mean-squared-error (MSE) or approximate symbol-error-rate (SER).

Backpropagation is discussed below.

Assuming that the transmission and reception blocks involved in the end-to-end transmission highlighted above at both the NW and the WTRU are differentiable or can be approximated as such, the WTRU and the NW may compute the derivatives of the measured difference between the generated training data X and the estimated training data Xₑ with respect to the AI/ML model parameters of the NW and the WTRU. In addition, the WTRU and the NW may transmit the resulting derivatives over the air between each other to perform the backpropagation through one or more (e.g., all) of the involved transmission and reception blocks to update their respective AI/ML models parameters. In examples, the input/output mapping of the AI/ML models at the WTRU (e.g., encoder) and the NW (e.g., decoder) can be formulated as L₁=f_{encoder}(W₁, CSI Estimate), and L₅=f_{decoder}(W₂, L₄), respectively. As depicted in FIG. 2, and using the differentiation chain rule, the derivative of the measured difference, denoted by Loss(X,Xₑ), with respect to the NW AI/ML model (e.g., decoder) parameters W₂ may be given by Equation 2.

$$\frac{dLoss ( X , {X}_{e} )}{{dW}_{2}} = \frac{dLoss ( X , {X}_{e} )}{{dX}_{e}} \times \frac{{dX}_{e}}{{dL}_{4}} \times \frac{{dL}_{4}}{{dL}_{3}} \times \frac{{dL}_{3}}{{dL}_{2}} \times \frac{{dL}_{2}}{{dW}_{2}} \qquad Equation 2$$

In Equation 2, the quantity

$$\frac{dLoss ( X , {X}_{e} )}{{dX}_{e}} \times \frac{{dX}_{e}}{{dL}_{4}} \times \frac{{dL}_{4}}{{dL}_{3}}$$

may be computed at the WTRU. The quantity

$$\frac{dLoss ( X , {X}_{e} )}{{dW}_{2}} = \frac{dLoss ( X , {X}_{e} )}{{dX}_{e}} \times \frac{{dX}_{e}}{{dL}_{4}} \times \frac{{dL}_{4}}{{dL}_{3}} \times \frac{{dL}_{3}}{{dL}_{2}} \times \frac{{dL}_{2}}{{dW}_{2}} \qquad Equation 2$$

may be computed at the NW. For the NW to compute the derivative of the measured difference with respect to the NW AI/ML model (e.g., decoder) parameters W₂, the WTRU needs to transmit over the air to the NW the quantity

$$\frac{dLoss ( X , {X}_{e} )}{{dX}_{e}} \times \frac{{dX}_{e}}{{dL}_{4}} \times \frac{{dL}_{4}}{{dL}_{3}} .$$

Based on this, the NW may update the NW AI/ML model (e.g., decoder) parameters using a learning algorithm, such as the stochastic gradient decent algorithm.

The derivative of the measured difference Loss(X,Xₑ) with respect to the WTRU AI/ML model (e.g., encoder) parameters W₁ is given by Equation 3.

$$\frac{dLoss ( X , {X}_{e} )}{{dW}_{2}} = \frac{dLoss ( X , {X}_{e} )}{{dX}_{e}} \times \frac{{dX}_{e}}{{dL}_{4}} \times \frac{{dL}_{4}}{{dL}_{3}} \times \frac{{dL}_{3}}{{dL}_{2}} \times \frac{{dL}_{2}}{{dL}_{1}} \times \frac{{dL}_{1}}{{dW}_{1}} \qquad Equation 3$$

In Equation 3, the quantities

$$\frac{dLoss ( X , {X}_{e} )}{{dX}_{e}} \times \frac{{dX}_{e}}{{dL}_{4}} \times \frac{{dL}_{4}}{{dL}_{3}} and \frac{{dL}_{1}}{{dW}_{1}}$$

may be computed at the WTRU. The quantity

$$\frac{{dL}_{3}}{{dL}_{2}} \times \frac{{dL}_{2}}{{dL}_{1}}$$

may be computed at the NW. For the WTRU to compute the derivative of the measured difference with respect to the WTRU AI/ML model (e.g., encoder) parameters W₁, the NW needs to transmit over the air to the WTRU the quantity

$$\frac{{dL}_{3}}{{dL}_{2}} \times \frac{{dL}_{2}}{{dL}_{1}} .$$

Based on this, the WTRU will update the WTRU AI/ML model (e.g., encoder) parameters using a learning algorithm, such as the gradient decent algorithm.

The process detailed above represents an example of the AI/ML models parameters update of at the WTRU and the NW in one single training session. This process may be repeated till convergence. For example, the WTRU may continually report the measured difference of each training session to the NW. The NW may assess the progress of the training by monitoring the evolution of the measured difference over multiple training sessions. In examples, if the measured difference is lower than a certain threshold, the NW may indicate to the WTRU that training is finished.

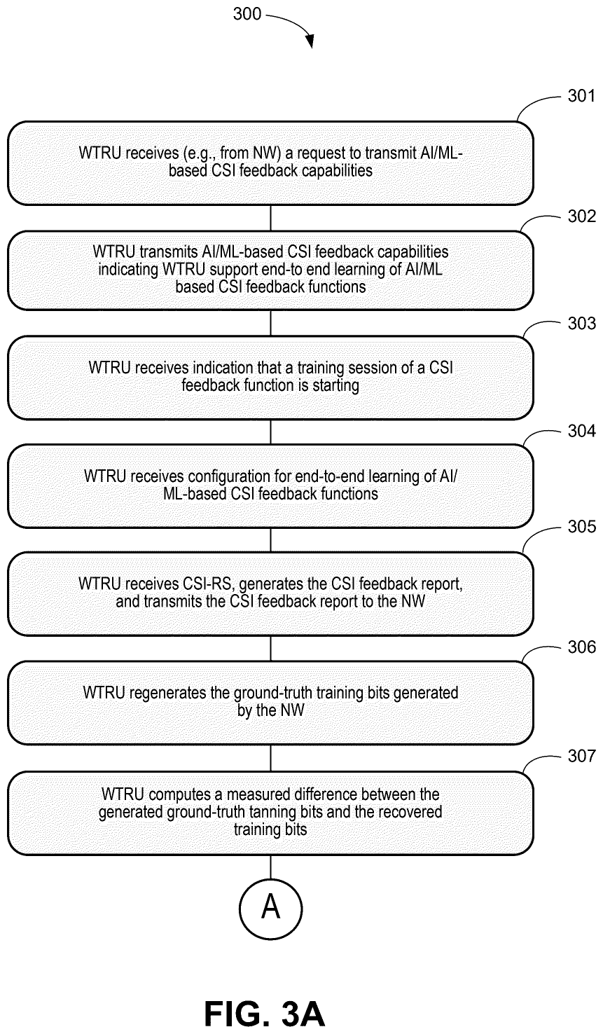

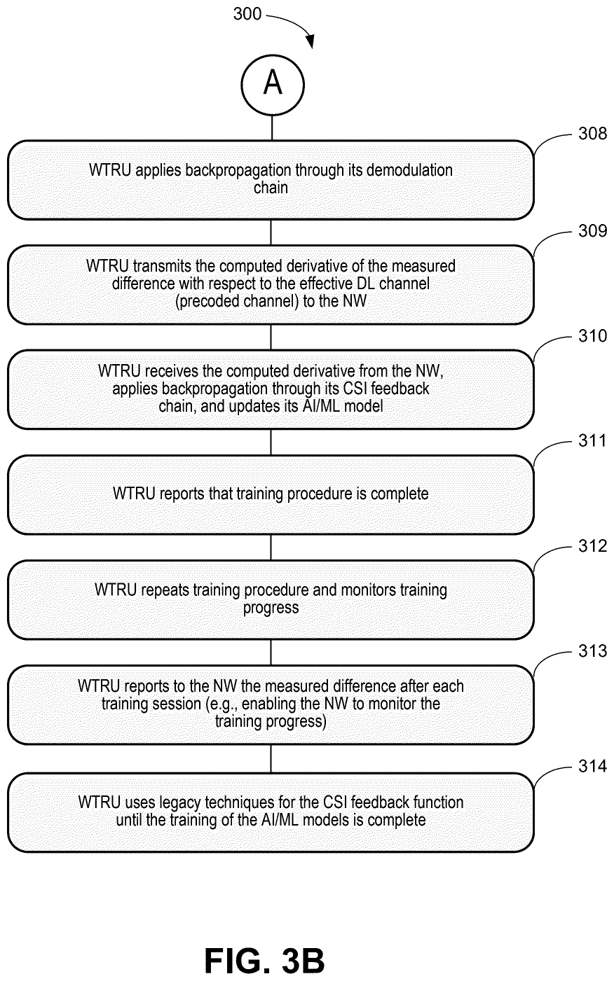

The WTRU procedures to perform end-to-end learning of CSI feedback functions are detailed below. An example procedure is depicted in FIG. 3A and FIG. 3B at 300. The term, NW, can refer to any node in the network (e.g., a gNB, another WTRU in Sidelink, WTRU-to-WTRU direct communication, etc.).

At 301 WTRU may receive (e.g., from NW) a request to transmit AI/ML-based CSI feedback capabilities. The WTRU may transmit its capabilities to the NW by means of RRC signaling.

At 302, the WTRU may transmit AI/ML-based CSI feedback capabilities indicating WTRU support for end-to-end learning of AI/ML-based CSI feedback functions.

At 303, the WTRU may receive an indication that a training session of a CSI feedback function is starting. The WTRU and NW may agree on a specific model architecture. A training session may refer to a set of one forward pass and one backpropagation over the AI/ML models at the NW and the WTRU. The WTRU may be triggered to initiate training of a CSI feedback function when the WTRU is configured to used AI/ML for that CSI feedback function (e.g., for a first time).

The WTRU or the NW may trigger a training session based on detecting a need to initiate training of an AI/ML-based CSI feedback function. In examples, a training session may be triggered based on AI/ML model drift detection mechanisms in the WTRU and/or the NW that indicate that the AI/ML model has drifted or is drifting. A training session may be triggered based on the WTRU entering a geographic region or a cell (e.g., a new cell id or a new registration area) for which the AI/ML model has not been previously trained. For example, the WTRU may compare GPS coordinates to measure distance to previously trained regions. If distance is above a threshold provided by the network, the WTRU may signals the network indicating the threshold is exceeded, and/or the distance and the current location.

The training sessions can be periodic, aperiodic, and/or semi-persistent. There could be a training session followed by a non-training session.

At 304, the WTRU may receive configuration for end-to-end learning of AI/ML-based CSI feedback functions. The configuration for end-to-end learning may comprise CSI-RS resource allocation. CSI-RS resource allocation may include, but is not limited to: CSI-RS periodicity, CSI-RS locations, CSI-RS density, etc.

The configuration for end-to-end learning may comprise CSI feedback reporting configuration. CSI feedback reporting configuration may include but is not limited to: Reporting type (e.g., periodic, semi-persistent, or aperiodic); report quantity (e.g., configuration of AI/ML-based CSI feedback report); and/or configuration of CSI feedback parameters. CSI feedback parameters may include, but are not limited to, the number of CSI estimates used for CSI feedback reporting, CSI feedback payload, quantization parameters. etc.

The configuration for end-to-end learning may comprise DMRS resource allocation, which may include, but is not limited to, DMRS periodicity, DMRS location, DMRS density, etc.

The configuration for end-to-end learning may comprise data resource allocation.

The configuration for end-to-end learning may comprise signals, transmission grants, and/or resource allocations associated to transmitting and receiving the derivatives in the UL (e.g., from the WTRU to the NW) and DL (e.g., from the NW to the WTRU).

The configuration for end-to-end learning may comprise training related information. The training related information may include, but is not limited to: The one or more pseudo-random seeds used to generate the training data at the NW; the measured difference to compute the training loss at the WTRU; the learning algorithm, learning rates, regularization parameters, etc.; the total number of training sessions and/or the loss thresholds to monitor the training progress.

At 305, the WTRU may receive CSI-RS, generate the CSI feedback report, and transmit the CSI feedback report to the NW. The WTRU receives CSI-RS according to the configuration. The WTRU may apply AI/ML-based techniques for CSI feedback reporting. The WTRU may be configured to apply channel encoding and modulation to the CSI feedback report, either separately or jointly with other uplink control information. The WTRU may be configured to use either the same (e.g., as other uplink control information) or different channel encoding and modulation schemes to the CSI feedback report. The WTRU may transmit the CSI feedback report to the NW. The WTRU may be configured to transmit the CSI feedback report on UCI, either on PUCCH or PUSCH, depending on the content and the periodicity of the CSI feedback report, and triggering can be received by MAC-CE or DCI.

The WTRU may receive a DL transmission from the NW, pass it through its demodulation chain, and recover the transmitted training data. The WTRU may receive DMRS according to the configuration. The WTRU may estimate the effective DL channel using the extracted DMRS. The WTRU may receive DL data according to the configuration.

At 306, the WTRU may generate or equivalently, may regenerate the ground-truth training data generated by the NW. The WTRU may do so by employing the same pseudo-random seeds used by the NW.

At 307, the WTRU may compute a measured difference between the generated ground-truth training data and the recovered training data. The measured difference metric can be either preconfigured or dynamically configured by the NW. Examples of the measured difference metric include, but are not limited to, binary-cross-entropy (BCE), approximate bit-error-rate (BER), mean-squared-error (MSE), approximate symbol-error-rate (SER), etc.

At 308, the WTRU may apply backpropagation through its demodulation chain. The WTRU may compute the derivative of the measured difference with respect to the effective DL channel (e.g., precoded DL channel). The WTRU may use the differentiation chain rule to compute the derivative. The WTRU may use the estimated DL channel when computing the derivative.
at 309, the WTRU may transmit the computed derivative of the measured difference with respect to the effective DL channel (e.g., precoded DL channel) to the NW. The WTRU may transmit the computed derivative on the UCI, either on PUCCH or PUSCH.
at 310, the WTRU may receive the computed derivative from the NW, apply backpropagation through its CSI feedback chain, and/or update its AI/ML model.

The WTRU may receive the computed derivatives of the precoded symbol (e.g., before DL transmission) with respects to the received CSI feedback report from the NW. The WTRU may receive the computed derivative through the DCI.

The WTRU may compute the derivative of the CSI feedback report with respect to the WTRU AI/ML model parameters.

The WTRU may computes the derivative of the measured difference with respects to the WTRU AI/ML model parameters using one or more (e.g., all) of the following: The computed derivative of the measured difference with respect to the effective DL channel (e.g., computed at the WTRU); the computed derivative of the precoded symbols with respect to the CSI feedback report (e.g., received from the NW); and/or the computed derivative of the CSI feedback report with respect to the WTRU AI/ML model parameters (e.g., computed at the WTRU).

The WTRU may use the computed derivative of the measured difference with respect to the WTRU AI/ML model parameters and a learning algorithm to update the WTRU AI/ML model parameters. The WTRU may employ the configured training parameters. Example of learning algorithm includes, but are not limited to, gradient descent.

At 311, the WTRU may report that the training procedure is complete. Steps to enable repetition of training procedure are discussed herein.

At 312, the WTRU may repeat the training procedure and monitor the training progress. The WTRU may store the measured differences computed during the training sessions. The WTRU may assess the progress of the measured difference over the training sessions.

If the measured difference is decreasing, the WTRU may compare the measured difference to the configured loss threshold. If the measured difference is lower than the loss threshold, The WTRU may indicate to the NW to stop the training. The WTRU may indicate to the NW to use the trained AI/ML models for the CSI feedback function. If the measured difference is higher than the first loss threshold, the WTRU may inform the NW to continue the training.

If the measured difference is increasing, The WTRU may inform the NW that the learning is diverging. In this case, the NW may change the learning parameters and/or configurations.

At 313, the WTRU may report to the NW the measured difference after each training session (e.g., enabling the NW to monitor the training progress).

At 314, the WTRU may use legacy techniques for the CSI feedback function until the training of the AI/ML models is complete.

Steps from the NW side are discussed herein.

The NW may receive the CSI feedback report and generate a DL precoder. The NW may generate the DL precoder associated to the CSI feedback report. The NW may employ legacy techniques (e.g., PMI codebook) to generate the DL precoder for the case of one-sided AI/ML-based CSI feedback functions. The NW may employ its AI/ML model to generate the DL precoder for the case of two-sided AI/ML-based CSI feedback functions.

The NW may generate precoded training data and transmits them to the WTRU. The NW may generate pseudo-random training data. The NW may employ a set of one or more preconfigured seeds to generate the pseudo-random training data.

In examples, training data can be binary bits or symbols. For cases where the training data are binary bits, the NW may generate the binary bits based on a set of one or more seeds. The NW may apply channel encoding (e.g., with a configured coding scheme) to generate the associated coded binary bits or may generate binary bits as a surrogate to the coded binary bits without channel encoding. Then, the NW may apply modulation to the binary bits to generate symbols. For cases where the training data are symbols, the NW may generate symbols based on a set of one or more seeds and a configured modulation. The NW may indicate to the WTRU which seeds it used to generate the pseudo-random training data. The NW and WTRU may agree on seed values based on a common observable such as system frame number and slot number. For one or more (e.g., all) cases, the NW may map the generated symbols to DL REs and insert DMRS. The NW may apply precoding to the generated symbols using the generated DL precoder. The NW may transmit the precoded symbols to the WTRU.

The NW may receive the computed derivative from the WTRU, apply backpropagation through its precoding and CSI reconstruction chains, and/or update the NW AI/ML model parameters.

The NW may receive the computed derivative of the measured difference with respect to the effective DL channel (e.g., precoded DL channel).

The NW may compute the derivatives of the precoded symbols (e.g., before DL transmission) with respect to the NW AI/ML model parameters.

The NW may compute the derivative of the measured difference with respects to the NW AI/ML model parameters using one or more (e.g., all) of the following: The computed derivative of the measured difference with respect to the effective DL channel (e.g., received from the WTRU); and/or the computed the derivative of the precoded symbols with respect to the NW AI/ML model parameters (e.g., computed at the NW).

The NW uses the computed derivative of the measured difference with respect to the NW AI/ML model parameters and a learning algorithm to update the NW AI/ML model parameters. Examples of learning algorithms include but are not limited to: the gradient descent.

The NW may compute the derivative of the precoded symbols (e.g., before DL transmission) with respects to the received CSI feedback report from the WTRU and transmit it to the WTRU.

AI/ML for Channel State Feedback (CSF) Reporting is discussed herein.

A WTRU may be configured (e.g., by a NW) to employ an AI/ML model for CSI feedback reporting. An example of CSI feedback function is CSI compression. The stages of an example AI/ML process are detailed as follows.

AI/ML processes may include an application stage. Application may include CSI feedback reporting (e.g., CSI Compression).

AI/ML processes may include Input data. Input data may comprise a DL CSI estimate (e.g., full raw channel or eigenvectors of the raw channel).

AI/ML processes may include Preprocessing. Preprocessing may involve one or more (e.g., all) of the following steps.

Preprocessing may include extracting the CSI-RS from the received signals by using the CSI-RS resource allocations.

Preprocessing may include division by (or multiplication by conjugate of) the known CSI-RS symbols.

Preprocessing may include applying an interpolation and/or a 2D filtering to the CSI-RS carrying REs.

Preprocessing may include applying singular value decomposition (SVD) to the estimated full DL raw channel if the CSI feedback reporting is based on the eigenvectors of the estimated full DL raw channel.

Preprocessing may include resizing the input data shape.

Preprocessing may include concatenation of the real and imaginary parts to obtain the real-valued input to the AI/ML model.

AI/ML processes may include an AI/ML model. For the CSI compression, various AI/ML models have been proposed in the literature including CsiNet, EVCsiNet, etc. Based on the autoencoder architecture, the AI/ML models for CSI compression employ an encoder at the WTRU to compress the DL CSI estimate (e.g., full raw channel or eigenvectors of the raw channel) into a low dimensional quantized-binary representation that is transmitted to the NW in the CSI feedback report. The AI/ML models for CSI compression may also employ a decoder at the NW to reconstruct the DL CSI estimate from the CSI feedback report.

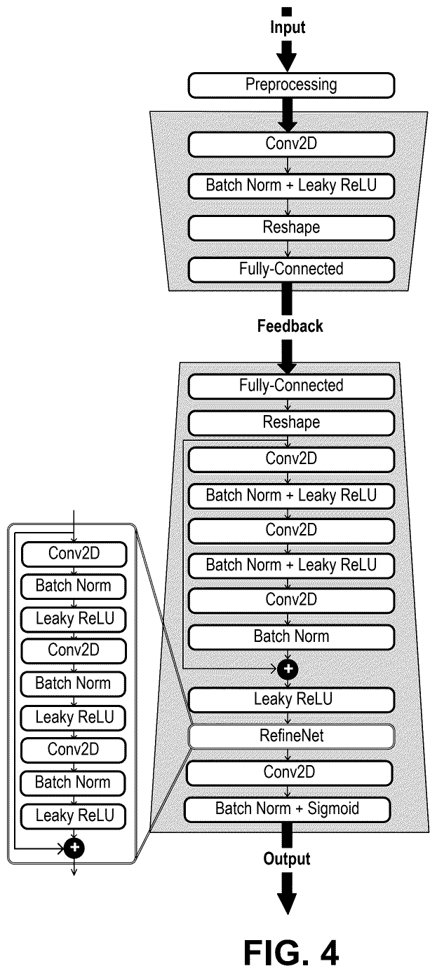

FIG. 4 presents an example of the CsiNet model architecture. CsiNet is a well-known AI/ML model structure comprising an encoder (the WTRU AI/ML model) and a decoder (the NW AI/ML model). Each of the encoder and the decoder comprise convolutional layers, batch normalization layers, leaky ReLU layers, Sigmoid activation layers, and residual connections.

For Temporal/Spatial/Frequency (TSF) CSI compression, the same AI/ML model architectures can be used, by adapting the input layer at the encoder to include the sequence of historical DL CSI estimates and including the historical reconstructed DL CSI estimates at the decoder.

AI/ML processes may include output data. In examples, output data may comprise a reconstructed DL CSI estimate.

AI/ML processes may include training. The training may be performed in an end-to-end manner as explained in the solution proposed in this disclosure.

Configuration is discussed below.

A NW may send configuration information for end-to-end training to a WTRU. When a WTRU is configured to update its AI/ML model for CSI feedback function using end-to-end learning, key parameters may be included in the configuration information sent by the NW. These key parameters may include but are be limited to one or more of the following.

The key parameters may include a CSI-RS resource allocation, which includes, but may not be limited to, CSI-RS periodicity, CSI-RS locations, CSI-RS density, etc.

The key parameters may include a CSI feedback reporting configuration, which includes, but may not be limited to: Reporting type (periodic, semi-persistent, or aperiodic). Report quantity (configuration of AI/ML-based CSI feedback report). Configuration of CSI feedback parameters, which includes, but may not be limited to, the number of CSI estimates used for CSI feedback reporting, CSI feedback payload, quantization parameters, etc.

The key parameters may include a DMRS resource allocation, which includes, but may not be limited to, DMRS periodicity, DMRS location, DMRS density, etc.

The key parameters may include a data resource allocation.

The key parameters may include transmission grants and/or resource allocations associated to transmitting the derivatives in the UL (e.g., from the WTRU to the NW) and DL (e.g., from the NW to the WTRU).

The key parameters may include a Training related information, which includes, but may not be limited to: The pseudo-random seeds used to generate the training data at the NW. The measured difference to compute the training loss at the WTRU. The learning algorithm, learning rates, regularization parameters, etc. The total number of training sessions. The loss threshold to monitor the training progress.

Signaling is discussed below.

For the end-to-end learning of CSI feedback functions, signaling may include one or more of the following.

Signaling for end-to-end CSI feedback functions may include a training activation or an indication that a training session is starting transmitted by the NW to the WTRU

Signaling for end-to-end CSI feedback functions may include the derivative of measured difference with respect to the DL precoded channel transmitted from the WTRU to the NW

Signaling for end-to-end CSI feedback functions may include the derivative of precoded symbols with respect to the CSI feedback report transmitted from the NW to the WTRU

Signaling for end-to-end CSI feedback functions may include the measured difference transmitted from the WTRU to the NW.

Signaling for end-to-end CSI feedback functions may include an Indication that training is complete transmitted from the WTRU to the NW.

The numerical results and assumptions of simulations are discussed below.

The numerical results are presented below for a performance evaluation of an example end-to-end learning technique for CSI feedback functions. The simulations were performed via Sionna, which is an open-source Python library for the link-level simulations based on TensorFlow. The simulation parameters are summarized in Table 1.

TABLE 1
Simulation parameters

| | | |
|---|---|---|
| | | Joint CSI Estimation, |
| | | Prediction and |
| Use Case | CSI Compression | Compression |

| | |
|---|---|
| Number of Antenna | 16 |

at NW

| | |
|---|---|
| Number of Antenna | 2 |

at WTRU

| | |
|---|---|
| Number of Layers L | 2 |

| | | |
|---|---|---|
| MCS | 7 | 6 |
| Channel Model | CDL-C | CDL-B |

| | |
|---|---|
| Carrier frequency | 2 GHz |
| Delay Spread | 300 ns |
| UE Velocity | 60 km/h |
| Subcarrier Spacing | 15 kHz |
| Number of RBs | 52 |
| Bandwidth | 10 MHz |
| Duplex Mode | TDD |

| | | |
|---|---|---|
| Input CSI Type | Full Raw | Least-Square |
| | Channel | Estimate |
| | Estimate | at CSI-RS |
| | | locations |
| Length of historical | N/A | 4 CSI |
| CSI sequence | | Estimates |
| | | (4 ms) |
| Prediction window | N/A | 1 CSI |
| | | Estimate |
| | | (1 ms) |
| CSI feedback delay | 5 ms | 1 ms |
| Number of latent | 128 | 200 |
| variables | | |
| Quantization | Scalar | No |
| | quantization | Quantization |
| | with 2 bits | |
| | per latent | |
| | variable | |

| | |
|---|---|
| UL Channel | Perfect |

For each of the two use cases, i.e., CSI Compression or Joint CSI Estimation, prediction, and compression, the techniques detailed in Table 2 are simulated.

TABLE 2
Proposed Solution and Baselines

| Technique | Type | Description |
|---|---|---|
| Proposed: End-to-End | AI/ML | End-to-end learning of the AI/ML |
| Learning (AI/ML − | | model where the AI/ML model at |
| CSF + Precoding) | | the NW directly generates the |
| | | DL precoder. Training data are |
| | | coded binary bits. |
| Proposed: End-to-End | AI/ML | End-to-end learning of the AI/ML |
| Learning (AI/ML − | | model where the AI/ML model at |
| CSF) | | the NW reconstructs the DL CSI |
| | | and then the NW determines the DL |
| | | precoder based on the reconstructed |
| | | CSI (e.g., zero-forcing precoding). |
| | | Training data are coded binary bits. |
| Baseline: Learning | AI/ML | Learning the AI/ML model with |
| with intermediate | | an intermediate KPI, which is the |
| KPI | | mean-square-error in this context. |
| | | This baseline is the adopted approach |
| | | by 3GPP Rel-18/Rel-19 to train the |
| | | AI/ML models for the AI/ML for CSI |
| | | feedback enhancement use case |
| | | (including CSI compression) [2], [3]. |
| Baseline: Rel-16 | Non- | This is a non-AI/ML baseline technique |
| Type II PMI | AI/ML | adopted in 3GPP Rel-18/Rel-19 for the |
| | | AI/ML for CSI feedback enhancement |
| | | use case (including CSI compression) |
| | | [2], [3]. |

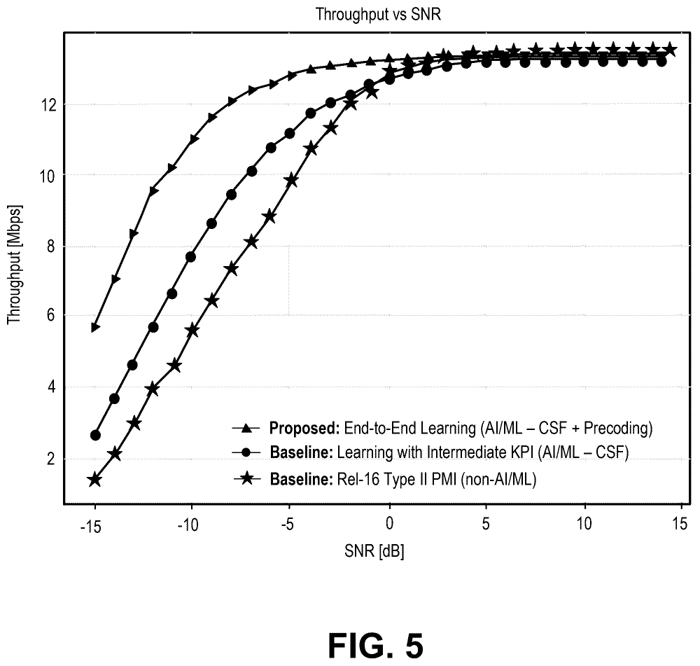

FIG. 5 shows throughput versus SNR of a proposed example solution featuring end-to-end learning and the baselines for the CSI Compression use case.

FIG. 5 presents the throughput performance versus signal-to-noise-ratio (SNR) for the proposed solution and the baselines (defined above) for use case 1: CSI compression. FIG. 5 demonstrates the significant gain resulting from end-to-end learning solution compared to learning with intermediate KPIs, such as the MSE for this case, as well as to non-AI/ML baseline that is the Rel-16 Type II PMI. For instance, for a target throughput of 10 Mbps, the proposed end-to-end learning solution provides around 4 dB SNR gain compared to learning with the intermediate KPI baseline and around 6.5 dB SNR gain compared to Rel-16 Type II PMI baseline.

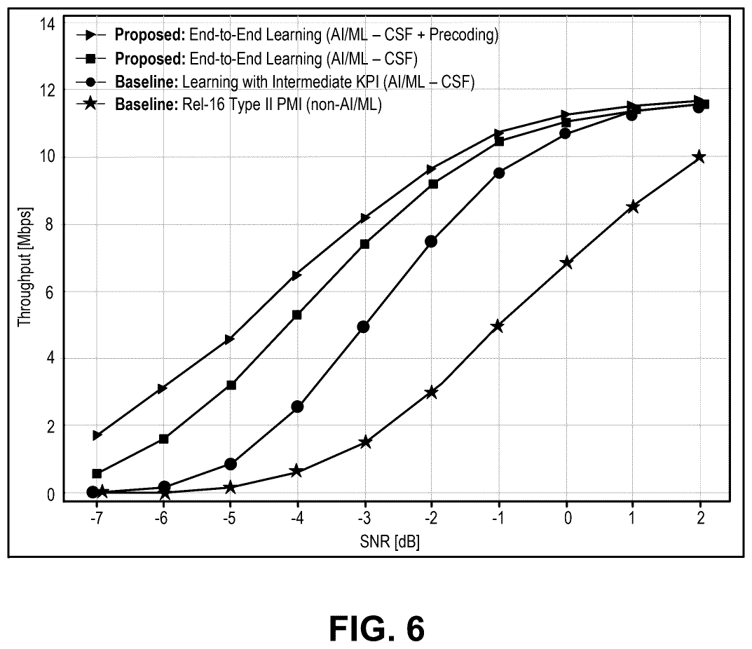

FIG. 6 shows throughput versus SNR of the proposed solution and the baselines for the CSI Joint CSI Estimation, Prediction, and Compression use case.

FIG. 6 presents the throughput performance versus signal-to-noise-ratio (SNR) for the proposed solution and the baselines defined above for use case 2: the joint CSI estimation, prediction and compression use case. This figure demonstrates the significant gain resulting from the proposed end-to-end learning solutions compared to learning with intermediate KPIs, such as the MSE for this case, as well as to non-AI/ML baseline that is the Rel-16 Type II PMI. For instance, for a target throughput of 6 Mbps, the proposed end-to-end learning solution with DL precoder directly generated from the AI/ML model at the NW provides around 2 dB SNR gain compared to learning with the intermediate KPI baseline and around 4 dB SNR gain compared to Rel-16 Type II PMI baseline. On the other hand, for the same target throughput of 6 Mbps, the proposed end-to-end learning solution with DL precoder generated based on the reconstructed DL CSI from the AI/ML model at the NW provides around 1 dB SNR gain compared to learning with the intermediate KPI baseline and around 4 dB SNR gain compared to Rel-16 Type II PMI baseline. Furthermore, one can note that the proposed end-to-end learning solution with DL precoder directly generated from the AI/ML model at the NW outperforms the proposed end-to-end learning solution with DL precoder generated based on the reconstructed DL CSI from the AI/ML model at the NW. This demonstrates the performance gain that can be achieved by the multi-block design of CSI feedback functions, i.e., multiple functions can be learned jointly through the same AI/ML model.

1. A wireless transmit/receive unit (WTRU) comprising:
a processor and memory, wherein the processor and memory are configured to:
receive configuration information, wherein the configuration information is associated with an artificial intelligence or machine learning (AI/ML) model that is configured to generate data for a channel state information (CSI) feedback report;
generate a set of ground truth training data based on one or more seed values;
receive downlink data from a network entity;
determine a set of training data based on the downlink data;
determine a loss function of the AI/ML model using the determined set of training data and the generated set of the ground truth training data;
compute a first set of one or more gradients of the loss function;
send the first set of one or more gradients to the network entity;
receive a second set of one or more gradients from the network entity;
update the AI/ML model based on the first and the second sets of one or more gradients.

2. The WTRU of claim 1, wherein the determined set of training data comprises uncoded binary bits, coded binary bits, or symbols.

3. The WTRU of claim 1, wherein the loss function indicates a difference between the generated set of ground truth training data and the determined set of training data.

4. The WTRU of claim 1, wherein the loss function is based on a binary-cross-entropy (BCE) or approximate bit-error-rate (BER) computation.

5. The WTRU of claim 1, wherein the loss function is based on a mean-squared-error (MSE) or approximate symbol-error-rate (SER) computation.

6. The WTRU of claim 1, wherein the processor and memory are configured to update the AI/ML model by performing backpropagation.

7. The WTRU of claim 1, wherein the processor and memory are configured to determine the set of ground truth training data using a pseudo-random number generation function, wherein the one or more seed values are used as input to the pseudo-random number generation function.

8. The WTRU of claim 1, wherein the processor and memory are configured to:
receive a request to transmit AI/ML-based CSI feedback capabilities; and
send capability information, wherein the capability information indicates WTRU support for end-to-end learning of AI/ML-based CSI feedback functions.

9. The WTRU of claim 1, wherein the processor and memory are configured to:
receive an indication that a training session of a CSI feedback function is starting.

10. The WTRU of claim 1, wherein the configuration information comprises an indication of the one or more seed values.

11. The WTRU of claim 1, wherein the processor and memory are configured to:
send an indication that training of the AI/ML model is complete based on the loss function being equal to or less than a threshold value.

12. The WTRU of claim 1, wherein the processor and memory are configured to:
receive a CSI reference signal (CSI-RS);
determine a CSI feedback report based on the CSI-RS using the AI/ML model; and
transmit the CSI feedback report to a network entity.

13. The WTRU of claim 1, wherein the processor and memory are configured to send the first set of one or more gradients to the network entity via uplink control information (UCI).

14. A method to be performed by a wireless transmit/receive unit (WTRU), the method comprising:
receiving configuration information, wherein the configuration information is associated with an artificial intelligence or machine learning (AI/ML) model that is configured to generate data for a channel state information (CSI) feedback report;
generating a set of ground truth training bits based on one or more seed values;
receiving downlink data from a network entity;
determining a set of training data based on the downlink data;
determining a loss function of the AI/ML model using the determined set of training data and the generated set of the ground truth training data;
computing a first set of one or more gradients of the loss function;
sending the first set of one or more gradients to the network entity;
receiving a second set of one or more gradients from the network entity;
updating the AI/ML model based on the first and the second sets of one or more gradients.

15. The method of claim 14, wherein the determined set of training data comprises uncoded binary bits, coded binary bits, or symbols.

16. The method of claim 14, wherein the loss function indicates a difference between the generated set of ground truth training data and the determined set of training data.

17. The method of claim 14, further comprising updating the AI/ML model by performing backpropagation.

18. A base station comprising a processor and memory, wherein the processor and memory are configured to:
send configuration information to a WTRU, wherein the configuration information is associated with a first artificial intelligence or machine learning (AI/ML) model that is configured to generate data for a channel state information (CSI) feedback report;
generate a set of training data based on one or more seed values;
send downlink data to the WTRU, wherein the downlink data indicates the set of training data bits;
receive a first set of one or more gradients from the WTRU;
determine a second set of one or more gradients;
send the second set of one or more gradients to the WTRU;
update a second AI/ML model based on the first and the second sets of one or more gradients.

19. The base station of claim 18, wherein the processor and memory are configured to update the second AI/ML model by performing backpropagation.

20. The base station of claim 18, wherein the processor and memory are configured to determine the training data using a pseudo-random number generation function, wherein the one or more seed values are used as input to the pseudo-random number generation function.
